(19) United States
(12) Patent Application Publication
(10) Pub. No.: US 2022/0417243 A1
(43) Pub. Date: Dec. 29, 2022

(54) PASSWORDLESS ACCESS TO VIRTUAL DESKTOPS

(71) Applicant: VMware, Inc., Palo Alto, CA (US)

(72) Inventors: Tarique Chowdhury, Barnet (GB); Per Olov Larsson, London (GB); Anurag Katiyar, Palo Alto, CA (US)

(73) Assignee: VMware, Inc., Palo Alto, CA (US)

(21) Appl. No.: 17/358,324

(22) Filed: Jun. 25, 2021

(51) Int. Cl. H04L 29/06; G06F 21/60; G06F 9/445

(52) U.S. Cl. CPC H04L 63/0884; G06F 21/602; H04L 63/0807; H04L 63/0823; G06F 9/44526; H04L 63/20; G06F 9/45558

(57) ABSTRACT

The present disclosure relates to methods, systems, and machine-readable media for passwordless access to virtual desktops. A request can be received to launch a virtual desktop provided by a software defined data center from a client having previously authenticated a user via a passwordless login. The client can be authenticated to a connection server and a virtual desktop. Authenticating the client to the virtual desktop can include receiving a request from the connection server to initiate a session, wherein the request includes an identifier generated by the client in association with the passwordless login, caching the identifier with the session, connecting to the client to establish a virtual channel connection, specifying a key storage provider to perform the authentication via the cached identifier, and performing cryptographic operations with the client via the virtual channel connection. The virtual desktop can be launched responsive to authenticating the client to the virtual desktop.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

A software defined data center can provide a virtual desktop. Virtual desktops are preconfigured images of operating systems and applications in which the desktop environment is separated from the physical device used to access it. A connection brokering service can connect the user to a desktop session so that the user can access the virtual desktop from any location without being constrained to a single device. In previous approaches, accessing a virtual desktop may first involve logging in to a physical device (e.g., an operating system) and then logging in to the virtual desktop by inputting a username and password, for instance.

### BRIEF DESCRIPTION OF THE DRAWINGS

FIG. 1 is a diagram of a host and a system for passwordless access to virtual desktops according to one or more embodiments of the present disclosure.

FIG. 2A is a flow chart associated with passwordless access to virtual desktops according to one or more embodiments of the present disclosure.

FIG. 2B is a diagram illustrating details of the policy enforcement component shown in FIG. 2A.

FIG. 3 is a diagram of a system for passwordless access to virtual desktops according to one or more embodiments of the present disclosure.

FIG. 4 is a diagram of a machine for passwordless access to virtual desktops according to one or more embodiments of the present disclosure.

FIG. 5 is a flow chart illustrating one or more methods for passwordless access to virtual desktops according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

Virtual desktops are preconfigured images of operating systems and applications in which the desktop environment is separated from the physical device used to access it. Users can access their virtual desktops remotely over a network. Any client device, such as a laptop, smartphone or tablet, can be used to access a virtual desktop. The software defined data center can install client software on the client device, and the user can then interact with that software on the device. Users can experience their desktop exactly the same way every time they log in, no matter which device they are logging into it from.

In previous approaches, accessing a virtual desktop may first involve logging in to a physical client device (e.g., an operating system of a client device) and then logging in to the virtual desktop by, for instance, inputting credentials (e.g., a username and password). However, the time-consuming effort spent logging in multiple times may frustrate users.

Some passwordless login systems are available for logging in to client devices. These systems verify a user's identity without the use of traditional passwords, which can be forgotten and are too easily compromised. One example of such a system, Microsoft Windows Hello for Business® (referred to herein as “WHFB”), allows users to login using a personal identification number (PIN) and/or a biometric input. Such solutions may be preferable to traditional password solutions both for ease-of-use and for security reasons. For instance, remembering a comparatively short PIN is easier than remembering a longer password. Also, such solutions provide enhanced security because they require physical presence at, or with, the client device (in the case of biometric security) and/or make use of the device's Trusted Platform Module (TPM). Passwordless login systems provision devices one by one and combine the information provisioned on each device (i.e., the cryptographic key) with additional information to authenticate users. On a system that has a TPM, the TPM can protect the key. If a system does not have a TPM, software-based techniques can be used to protect the key. The additional information the user supplies can be a PIN or, if the system has appropriate hardware, biometric information, such as fingerprint, facial recognition, eye scan, etc. To protect privacy, the biometric information is used only on the provisioned device to access the provisioned key; it is not shared across devices.

Embodiments of the present disclosure can leverage the ease-of-use and the security afforded by such passwordless login solutions to provide streamlined, secure access to virtual desktops, even in cases where virtual desktops are not provisioned or set up with a passwordless login. For instance, once a user is authenticated, any process running in the user's session can access a passwordless login key/certificate store because embodiments herein can cache the authentication state. More generally, a passwordless login by a user unlocks access to a certificate/private key. When a virtual desktop is launched, it connects to a connection server. Such a connection can be enabled by a feature known as “Login as Current User” (LACU). LACU allows the credentials provided when logging in to the client device to be used for authenticating to the connection server (e.g., using Kerberos or NT LAN Manager (NTLM), discussed further below). Once authenticated, the user's provisions are presented, and, when the user launches a virtual desktop, instead of prompting the user for credentials, embodiments herein can perform a certificate logon for the user with a custom Key Storage Provider (KSP). The custom KSP redirects cryptographic requests from the remote desktop to the client device over a virtual channel. Through the custom KSP, the requests for the user's certificate, along with cryptographic operations, can be performed and presented back to the passwordless login system during the logon process. As a result, single sign-on (SSO) for the user can be achieved on the remote desktop using the passwordless login solution certificate available on the client device.

It is noted that for purposes of illustration the present disclosure discusses some embodiments in the context of a specific example of a passwordless login system (WHFB) and a specific example of a passwordless login system provider (Microsoft Windows). However, such discussion is not to be taken in a limiting sense. Embodiments of the present disclosure are compatible with passwordless login systems different from, and in addition to, those specifically discussed as examples herein.

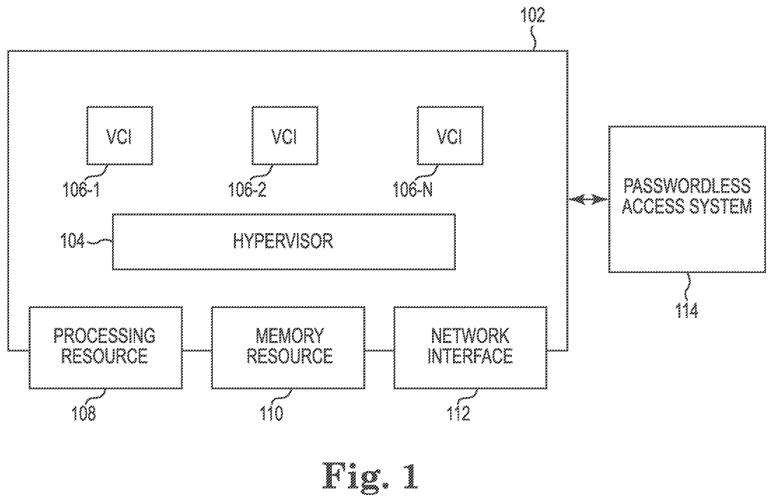

As used herein with respect to VCIs, a “disk” is a representation of memory resources (e.g., memory resources 110 illustrated in FIG. 1) that are used by a VCI. As used herein, “memory resource” includes primary storage (e.g., cache memory, registers, and/or main memory such as random access memory (RAM)) and secondary or other storage (e.g., mass storage such as hard drives, solid state drives, removable media, etc., which may include non-volatile memory). The term “disk” does not imply a single physical memory device. Rather, “disk” implies a portion of memory resources that are being used by a VCI, regardless of how many physical devices provide the memory resources.

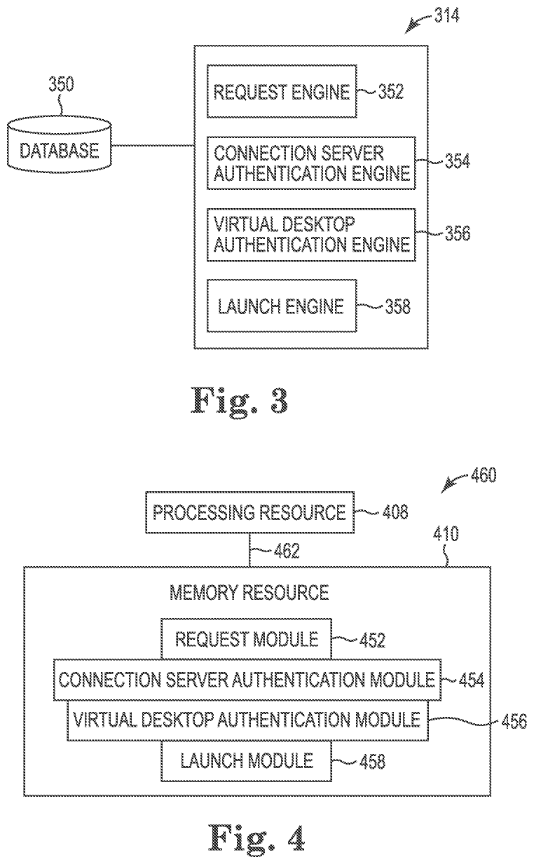

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 408 in FIG. 4. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

FIG. 1 is a diagram of a host and a system for passwordless access to virtual desktops according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with a passwordless access system 114. An example of the passwordless access system is illustrated and described in more detail below. In some embodiments, the passwordless access system 114 can be a server, such as a web server.

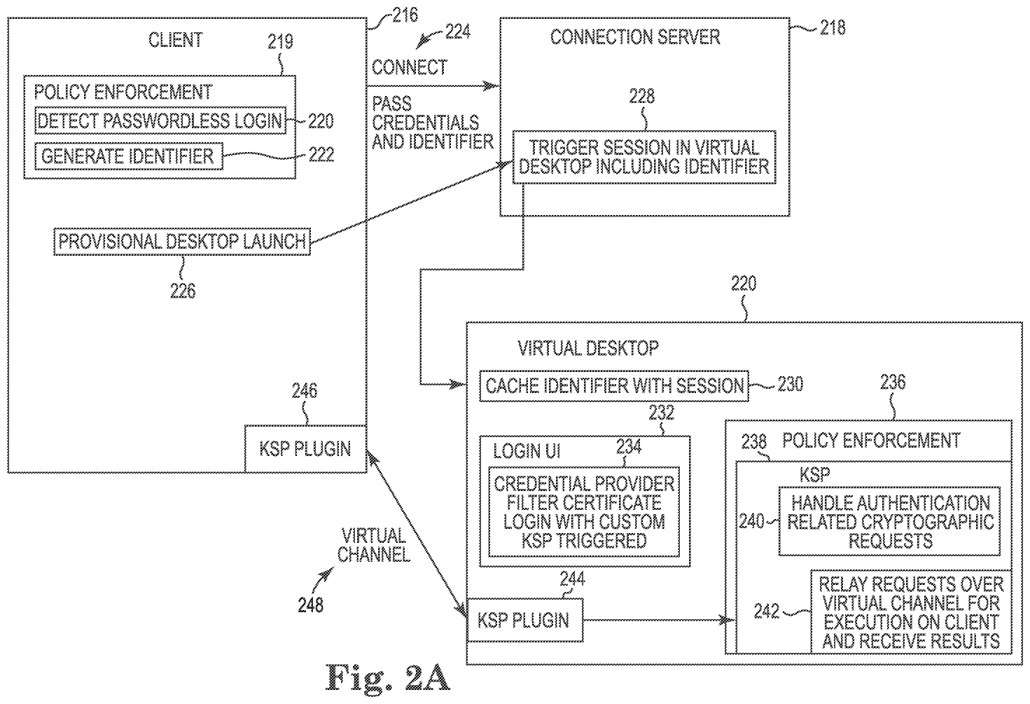

FIG. 2A is a flow chart associated with passwordless access to virtual desktops according to one or more embodiments of the present disclosure. As shown in FIG. 2A, embodiments of the present disclosure can include communication with three entities. A client device 216 (referred to herein simply as “client 216”) can communicate with a connection server 218 and a virtual desktop 220. The connection server 218 may be referred to in the art as a broker and the virtual desktop 220 may be referred to in the art as an agent, a guest desktop, a remote desktop, a virtual desktop infrastructure (VDI), and/or by another name.

The client 216 can be a computing device, such as a desktop computing device, laptop, smartphone, tablet, etc. The client 216 can be enrolled in a passwordless login system. As previously discussed, the passwordless login system can be WHFB, though it is again noted that embodiments herein are not so limited. It is to be understood that the passwordless login functionality of the client 216 has been set up. For example, a personal identification number (PIN) and/or biometrics authentication on the client 216 has been set up. In addition, the user of the client 216 can have a passwordless login certificate enrolled into the user's certificate store. In an example, a certificate can be named File:WHFB-user-certificate.cer. The user can log in to the client 216 (e.g., the local desktop of the client 216) using the passwordless login.

The connection server 218 can be a broker for client connections. The connection server 218 can authenticate users through an active director (e.g., Windows Active Directory) and direct requests to the appropriate VCI, physical computing device, and/or host. The virtual desktop 220 can be provided by a software defined data center. Generally, the virtual desktop 220 comprises preconfigured image(s) of operating systems and applications in which the desktop environment is separated from the physical device (e.g., the client 216) used to access it. The connection server 218 can connect the user to a session with the virtual desktop 220 so that the user can access the virtual desktop 220 from any location without being constrained to a single device.

The client 216 includes policy enforcement component 219. Policy enforcement component 219 is responsible for enforcing the security policy on the client 216. Policy enforcement component 219 verifies users logging on to the client 216, handles password changes, and creates access tokens. In an example, the policy enforcement component 219 is a Local Security Authority Subsystem Service (LSASS). The policy enforcement component 219 detects, at 220, a passwordless login. In an example, the policy enforcement component 219 detects that WHFB credentials were used to login to the client 216 (e.g., via an authentication package).

As shown at 224, the client can connect to the connection server 218. In some embodiments, Login As Current User (LACU) can be used and the client 216 can be authenticated to the connection server 218 via a ticket-based authentication protocol login (e.g., Kerberos). In some embodiments, the client 216 can be authenticated to the connection server 218 via a new technology local area network manager (NTLM) login. In some embodiments, such as those employing a unified access gateway (UAG), authenticating the client 216 to the connection server 218 includes performing a certificate login using a passwordless login certificate of the client 216. For instance, the certificate can be used to pre-authenticate to the UAG and then LACU can be used to authenticate to the connection server 218. In some embodiments, certificate authentication can be performed via a Secure Sockets Layer (SSL) and/or Transport Layer Security (TLS) handshake.

The connection server 218 can enumerate a list of applications and/or desktops the user is provisioned with and/or entitled to and present them back to the client 216. At 226, a selected provisioned desktop (e.g., virtual desktop 220) is launched. It is noted that the virtual desktop 220 is not set up and/or provisioned for passwordless login. Upon the launch at 226, the client 216 requests a passwordless login from the connection server 218 and passes login credentials (e.g., user details) and a session identifier generated at 222. The session identifier can be a numeric identifier. The session identifier is a temporary identifier that may be specific to a session triggered, at 228, by the connection server 218 in the virtual desktop 220. The launch at 226 can cause the connection server 218 to determine an appropriate host (e.g., via VDI and/or a Remote Desktop Session Host (RDSH)). The session triggered at 228 can comprise a “startsession” request sent to the virtual desktop 220. Included in this request can be a request for passwordless login (e.g., a WHFB authentication request) and the session identifier generated at 222 by the client 216.

The virtual desktop 220 can include a desktop manager, which can prepare the virtual desktop 220 for an incoming connection from the client 216 and cache the session identifier in association with the session at 230. The desktop manager of the virtual desktop 220 can respond to the connection server 218 that the session is ready. The connection server 218 can then respond to the client 216 with details regarding how to connect to the virtual desktop 220. Caching the session identifier in association with the session in the KSP 238 at 230 can limit access to any process running as the user within the session. That way, if an application running on the virtual desktop 220 during the session attempts to use the certificate and private key, it will be able to do so even if the user is unaware of the session identifier. If not for such caching, the user would be prevented from accessing the private key from any applications because of the user's ignorance of the session identifier.

The client 216 connects with the virtual desktop 220, establishing a virtual channel 248. The virtual channel connection 248 can be enabled via a virtual channel plugin loaded on both the client 216 and the virtual desktop 220. In FIG. 2, the virtual channel plugin loaded on the client 216 is shown as KSP plugin 246, and the virtual channel plugin loaded on the virtual desktop 220 is shown as KSP plugin 244.

The virtual desktop 220 can include a login user interface (referred to herein as “login UI 232.” The login UI 232 can implement a credential provider filter 234. In an example, the credential provider filter 234 is wscredf. The credential provider filter 234 can create a serialized structure that includes the session identifier and login credentials, and specifies a KSP 238 to perform the authentication for the user via the cached session identifier. The login UI 232 can begin the login process. The login UI 232 can initiate a login process (e.g., a winlogon process), which can pass along the serialized credentials to a policy enforcement component 236 on the virtual desktop. In an example, the login process can involve a LsaLogonUser function, which authenticates a security principal's logon data by using stored credentials information.

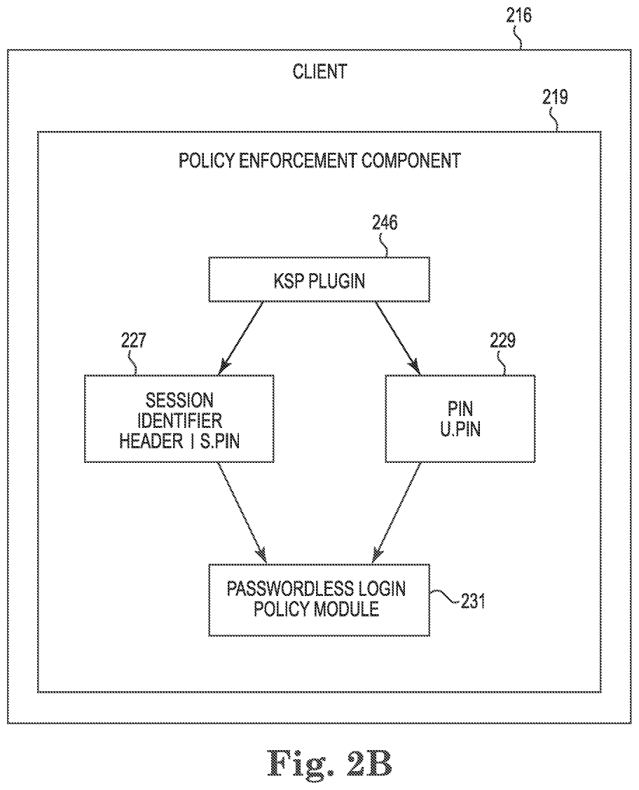

During authentication, the policy enforcement component 236 communicates, at 240, authentication-related cryptographic requests to the KSP 238. The KSP communicates these requests to, and receives results from, the client at 242. For instance, the KSP 238 can redirect each communication from the policy enforcement component 236 to the client 216 over the virtual channel 248 via the KSP plugin 244. On the client side, the policy enforcement component 219 of the client, (discussed further below in connection with FIG. 3) can execute any cryptographic requests and return those results via the KSP plugin 246 over the virtual channel 248 to the virtual desktop 220. The returned results are then communicated by the KSP 238 to the policy enforcement component 236. Once authentication is complete, the login UI 232 prepares the session by loading user profiles, executing login scripts, and preparing the virtual desktop 220 for display. Stated differently, the virtual desktop can be launched in response to authenticating the client 216 to the virtual desktop 220.

The cryptographic requests redirected from the policy enforcement component 236 to the client 216 (e.g., the policy enforcement component 219 of the client 216, discussed below in connection with FIG. 2B), and the responses thereto communicated back to the policy enforcement component 236 are referred to herein as cryptographic operations. Example cryptographic operations can include “Get Certificate,” “Sign Hash,” and “Verify PIN.” The operation “Get Certificate” can cause the client 216 to return a passwordless login certificate. In some embodiments, the passwordless login certificate is an end-entity certificate Smartcard Logon Certificate with an extended property: CERT_KEY_PROV_INFO_PROP_ID. The operation “Sign Hash” can be performed using an associated private key which, in an example, resides in MS_NGC_KEY_STORAGE_PROVIDER (a passport key storage provider). The operation “Verify PIN” can be performed by the policy enforcement component 219 of the client 216 to verify the user's passwordless login PIN against the key whose name is stored with the private key's custom property NgcSCardReaderAndContainerName.

In some instances, after the virtual desktop 220 is launched, it may enter a locked state. In some embodiments, a locked state occurs after a period of user inactivity, which may be known as a sleep state. In some embodiments, a locked state occurs because of user input. For example, the user can “lock” the desktop. Embodiments herein can determine that the virtual desktop has entered a locked state and unlock the virtual desktop in response to re-authenticating the user via an additional passwordless login. Stated differently, the user may be able to unlock the virtual desktop by re-entering the PIN and/or the biometric input initially used to authenticate the user to the client 216. Such re-entry may be caused, for instance, due to an expiration of the temporary session and/or the session identifier discussed above. The user can be prompted to re-enter the PIN and/or the biometric input by the login UI 232, for instance.

FIG. 2B is a diagram illustrating details of the policy enforcement component 219 shown in FIG. 2A. The policy enforcement component 219 of the client 216 can grant access to private key operations using a session identifier 227 and/or a PIN 229 (e.g., a user PIN).

To prevent unauthorized usage of the private key on the client 216, embodiments herein generate a unique session identifier 227 (shown in FIG. 2B as “HEADER|S.PIN”). The session identifier 227 is unique to the session established between the client 216 and the connection server 218 and, as previously discussed in connection with FIG. 2A, is passed from the client 216 to the connection server 218, and then from the connection server 218 to the virtual desktop 220.

In some embodiments, such as those previously discussed in which the virtual desktop 220 enters a locked state, the user can supply a PIN 229 (shown in FIG. 2B as “U.PIN”) known to the user. To grant access to private key operations using the PIN 229, the policy enforcement component 219 can validate the PIN 229 against the session identifier 227. If this validation fails, the policy enforcement component 219 can call a passwordless login policy module 231 to determine if it can validate the PIN 229. However, repeated calls to such a module with an incorrect PIN may cause assess to the private key to be blocked. Once access is blocked, an administrator may be needed, and, in some cases, unblocking may involve re-provisioning the module 231 with a new key and/or certificate.

To reduce the risk of locking access to the underlying key, some embodiments include modifying the operation of the policy enforcement component 219. In one example, the policy enforcement component 219 can be configured to only allow authentication using the session identifier 227 and not call the underpinning passwordless login policy module 231 to validate the PIN 229. In another example, the session identifier 227 can be prefixed with a predefined header identifying the session identifier 227 as such. Then, when the virtual desktop 230 requests access, the policy enforcement component 219 of the client 216 can interrogate the PIN 229 to determine if it is a session identifier 227. If so, such embodiments can avoid falling back to validating the PIN 229 using the passwordless login policy module 231. In another example, the policy enforcement component 219 of the client 216 can keep a counter of a quantity of failed PIN 229 validation attempts received from the virtual desktop 230 (or other virtual desktops) and once a PIN validation fails it may prevent any further validations in order to avoid locking access to the underpinning key and/or certificate. Additionally, to reduce the risk of locking access to the underlying key, some embodiments include modifying the operation of the policy enforcement component 236 of the virtual desktop 230. In one example, the policy enforcement component 236 can be configured to only allow authentication using the session identifier 227 and prevent a user onlooking the system from using a user PIN.

FIG. 3 is a diagram of a system 314 for passwordless access to virtual desktops according to one or more embodiments of the present disclosure. The system 314 can include a database 350 and/or a number of engines, for example request engine 352, connection server authentication engine 354, virtual desktop authentication engine 356, and/or launch engine 358, and can be in communication with the database 350 via a communication link. The system 314 can include additional or fewer engines than illustrated to perform the various functions described herein. The system 314 can represent program instructions and/or hardware of a machine (e.g., machine 460 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the request engine 352 can include a combination of hardware and program instructions that is configured to receive a request to launch a virtual desktop provided by a software defined data center from a client device having previously authenticated a user via a passwordless login. In some embodiments, the connection server authentication engine 354 can include a combination of hardware and program instructions that is configured to authenticate the client device to a connection server.

In some embodiments, the virtual desktop authentication engine 356 can include a combination of hardware and program instructions that is configured to authenticate the client device to the virtual desktop using the passwordless login. In some embodiments, the combination of hardware and program instructions of the virtual desktop authentication engine 356 are configured to receive a request from the connection server to initiate a session, wherein the request includes an identifier generated by the client device in association with the passwordless login, cache the identifier with the session, connect to the client device to establish a virtual channel connection, specify a KSP to perform the authentication via the cached identifier, and perform cryptographic operations with the client device via the virtual channel connection. In some embodiments, the launch engine 358 can include a combination of hardware and program instructions that is configured to launch the virtual desktop in response to authenticating the client device to the virtual desktop.

FIG. 4 is a diagram of a machine for passwordless access to virtual desktops according to one or more embodiments of the present disclosure. The machine 460 can utilize software, hardware, firmware, and/or logic to perform a number of functions. The machine 460 can be a combination of hardware and program instructions configured to perform a number of functions (e.g., actions). The hardware, for example, can include a number of processing resources 408 and a number of memory resources 410, such as a machine-readable medium (MRM) or other memory resources 410. The memory resources 410 can be internal and/or external to the machine 460 (e.g., the machine 460 can include internal memory resources and have access to external memory resources). In some embodiments, the machine 460 can be a VCI. The program instructions (e.g., machine-readable instructions (MRI)) can include instructions stored on the MRM to implement a particular function (e.g., an action such as launching a virtual desktop). The set of MRI can be executable by one or more of the processing resources 408. The memory resources 410 can be coupled to the machine 460 in a wired and/or wireless manner. For example, the memory resources 410 can be an internal memory, a portable memory, a portable disk, and/or a memory associated with another resource, e.g., enabling MM to be transferred and/or executed across a network such as the Internet. As used herein, a “module” can include program instructions and/or hardware, but at least includes program instructions.

Memory resources 410 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 408 can be coupled to the memory resources 410 via a communication path 462. The communication path 462 can be local or remote to the machine 460. Examples of a local communication path 462 can include an electronic bus internal to a machine, where the memory resources 410 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 462 can be such that the memory resources 410 are remote from the processing resources 408, such as in a network connection between the memory resources 410 and the processing resources 408. That is, the communication path 462 can be a network connection. Examples of such a network connection can include a local area network (LAN), wide area network (WAN), personal area network (PAN), and the Internet, among others.

As shown in FIG. 4, the MM stored in the memory resources 410 can be segmented into a number of modules 452, 454, 456, 458 that when executed by the processing resources 408 can perform a number of functions. As used herein a module includes a set of instructions included to perform a particular task or action. The number of modules 452, 454, 456, 458 can be sub-modules of other modules. For example, the connection server authentication module 454 can be a sub-module of the request module 452 and/or can be contained within a single module. Furthermore, the number of modules 452, 454, 456, 458 can comprise individual modules separate and distinct from one another. Examples are not limited to the specific modules 452, 454, 456, 458 illustrated in FIG. 4.

Each of the number of modules 452, 454, 456, 458 can include program instructions and/or a combination of hardware and program instructions that, when executed by a processing resource 408, can function as a corresponding engine as described with respect to FIG. 3. For example, the request module 452 can include program instructions and/or a combination of hardware and program instructions that, when executed by a processing resource 408, can function as the request engine 352, though embodiments of the present disclosure are not so limited.

The machine 460 can include a request module 452, which can include instructions to receive a request to launch a virtual desktop provided by a software defined data center from a client device having previously authenticated a user via a passwordless login. The machine 460 can include a connection server authentication module 454, which can include instructions to authenticate the client device to a connection server.

The machine 460 can include a virtual desktop authentication module 456, which can include instructions to authenticate the client device to the virtual desktop using the passwordless login. The instructions to authenticate the client device to the virtual desktop can include instructions to receive a request from the connection server to initiate a session, wherein the request includes an identifier generated by the client device in association with the passwordless login, cache the identifier with the session, connect to the client device to establish a virtual channel connection, specify a KSP to perform the authentication via the cached identifier, and perform cryptographic operations with the client device via the virtual channel connection. The machine 460 can include a launch module 458, which can include instructions to launch the virtual desktop in response to authenticating the client device to the virtual desktop.

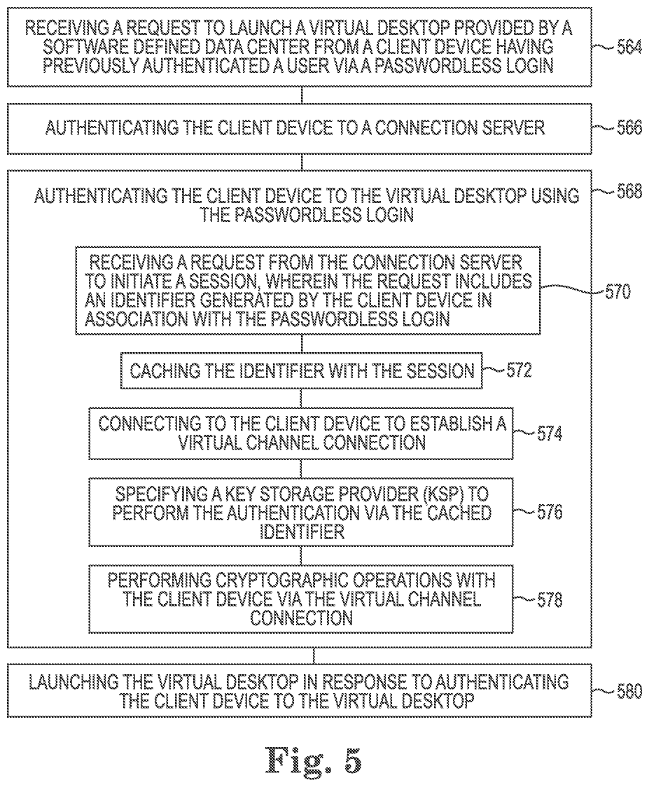

FIG. 5 is a flow chart illustrating one or more methods for passwordless access to virtual desktops according to one or more embodiments of the present disclosure. The method can include, at 564, receiving a request to launch a virtual desktop provided by a software defined data center from a client device having previously authenticated a user via a passwordless login.

The method can include, at 566, authenticating the client device to a connection server. In some embodiments, authenticating the client device to the connection server includes authenticating the client device to the connection server via a LACU process performing a NTLM login. In some embodiments, authenticating the client device to the connection server includes authenticating the client device to the connection server via the LACU process performing a ticket-based authentication protocol login (e.g., Kerberus). In some embodiments, authenticating the client device to the connection server includes performing a certificate login using a passwordless login certificate of the client device.

The method can include, at 568, authenticating the client device to the virtual desktop using the passwordless login. Authenticating the client device to the virtual desktop can include, at 570, receiving a request from the connection server to initiate a session, wherein the request includes an identifier generated by the client device in association with the passwordless login. The identifier can be a temporary identifier specific to the session. Authenticating the client device to the virtual desktop can include, at 572, caching the identifier with the session.

Authenticating the client device to the virtual desktop can include, at 574, connecting to the client device to establish a virtual channel connection. Connecting to the client device to establish the virtual channel connection can include loading a virtual channel plugin associated with the KSP on the client device and the virtual desktop. Authenticating the client device to the virtual desktop can include, at 576, specifying a KSP to perform the authentication via the cached identifier.

Authenticating the client device to the virtual desktop can include, at 578, performing cryptographic operations with the client device via the virtual channel connection. Performing cryptographic operations with the client device via the virtual channel connection can include redirecting cryptographic requests from the KSP to the client device via the virtual channel connection. Performing cryptographic operations with the client device via the virtual channel connection can include receiving results of the cryptographic requests executed by the virtual channel plugin of the client device via the virtual channel connection.

The method can include, at 580, launching the virtual desktop in response to authenticating the client device to the virtual desktop. In some embodiments, the method can include determining the virtual desktop has entered a locked state subsequent to launching the virtual desktop, and unlocking the virtual desktop in response to re-authenticating the user via an additional passwordless login.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving a request to launch a virtual desktop provided by a software defined data center from a client device having previously authenticated a user via a passwordless login;
authenticating the client device to a connection server;
authenticating the client device to the virtual desktop using the passwordless login, including:
receiving a request from the connection server to initiate a session, wherein the request includes an identifier generated by the client device in association with the passwordless login;
caching the identifier with the session;
connecting to the client device to establish a virtual channel connection;
specifying a key storage provider (KSP) to perform the authentication via the cached identifier; and
performing cryptographic operations with the client device via the virtual channel connection; and
launching the virtual desktop in response to authenticating the client device to the virtual desktop.

2. The method of claim 1, wherein authenticating the client device to the connection server includes:
authenticating the client device to the connection server via a login as current user (LACU) process performing a new technology local area network manager (NTLM) login; or
authenticating the client device to the connection server via the LACU process performing a ticket-based authentication protocol login.

3. The method of claim 1, wherein authenticating the client device to the connection server includes performing a certificate login using a passwordless login certificate of the client device.

4. The method of claim 1, wherein the identifier is a temporary identifier specific to the session.

5. The method of claim 1, wherein connecting to the client device to establish the virtual channel connection includes loading a virtual channel plugin associated with the KSP on the client device and the virtual desktop.

6. The method of claim 5, wherein performing cryptographic operations with the client device via the virtual channel connection includes:
redirecting cryptographic requests from the KSP to the client device via the virtual channel connection; and
receiving results of the cryptographic requests executed by the virtual channel plugin of the client device via the virtual channel connection.

7. The method of claim 1, wherein the method includes:
determining the virtual desktop has entered a locked state subsequent to launching the virtual desktop; and
unlocking the virtual desktop in response to re-authenticating the user via an additional passwordless login.

8. A non-transitory computer-readable medium having instructions stored thereon which, when executed by a processor, cause the processor to:
receive a request to launch a virtual desktop provided by a software defined data center from a client device having previously authenticated a user via a passwordless login;
authenticate the client device to a connection server;
authenticate the client device to the virtual desktop using the passwordless login, including:
receive a request from the connection server to initiate a session, wherein the request includes an identifier generated by the client device in association with the passwordless login;
cache the identifier with the session;
connect to the client device to establish a virtual channel connection;
specify a key storage provider (KSP) to perform the authentication via the cached identifier; and
perform cryptographic operations with the client device via the virtual channel connection; and
launch the virtual desktop in response to authenticating the client device to the virtual desktop.

9. The medium of claim 8, wherein the instructions to authenticate the client device to the connection server include instructions to:
authenticate the client device to the connection server via a login as current user (LACU) process performing a new technology local area network manager (NTLM) login; or
authenticate the client device to the connection server via the LACU process performing a ticket-based authentication protocol login.

10. The medium of claim 8, wherein the instructions to authenticate the client device to the connection server include instructions to perform a certificate login using a passwordless login certificate of the client device.

11. The medium of claim 8, wherein the identifier is a temporary identifier specific to the session.

12. The medium of claim 8, wherein the instructions to connect to the client device to establish the virtual channel connection include instructions to load a virtual channel plugin associated with the KSP on the client device and the virtual desktop.

13. The medium of claim 12, wherein the instructions to perform cryptographic operations with the client device via the virtual channel connection include instructions to:
redirect cryptographic requests from the KSP to the client device via the virtual channel connection; and
receive results of the cryptographic requests executed by the virtual channel plugin of the client device via the virtual channel connection.

14. The medium of claim 8, including instructions to:
determine the virtual desktop has entered a locked state subsequent to launching the virtual desktop; and
unlock the virtual desktop in response to re-authenticating the user via an additional passwordless login.

15. A system, comprising:
a request engine configured to receive a request to launch a virtual desktop provided by a software defined data center from a client device having previously authenticated a user via a passwordless login;
a connection server authentication engine configured to authenticate the client device to a connection server;
a virtual desktop authentication engine configured authenticate the client device to the virtual desktop using the passwordless login, including:
receiving a request from the connection server to initiate a session, wherein the request includes an identifier generated by the client device in association with the passwordless login;
caching the identifier with the session;
connecting to the client device to establish a virtual channel connection;
specifying a key storage provider (KSP) to perform the authentication via the cached identifier; and
performing cryptographic operations with the client device via the virtual channel connection; and
a launch engine configured to launch the virtual desktop in response to authenticating the client device to the virtual desktop.

16. The system of claim 15, wherein the connection server authentication engine is configured to:
authenticate the client device to the connection server via a login as current user (LACU) process performing a new technology local area network manager (NTLM) login; or
authenticate the client device to the connection server via the LACU process performing a ticket-based authentication protocol login.

17. The system of claim 15, wherein the connection server authentication engine is configured to perform a certificate login using a passwordless login certificate of the client device.

18. The system of claim 15, wherein the identifier is a temporary identifier specific to the session.

19. The system of claim 15, wherein the virtual desktop authentication engine is configured to load a virtual channel plugin associated with the KSP on the client device and the virtual desktop.

20. The system of claim 19, wherein the virtual desktop authentication engine is configured to:
redirect cryptographic requests from the KSP to the client device via the virtual channel connection; and
receive results of the cryptographic requests executed by the virtual channel plugin of the client device via the virtual channel connection.
